(19) United States
(12) Patent Application Publication
(10) Pub. No.: US 2009/0201541 A1
(43) Pub. Date: Aug. 13, 2009

(54) SYSTEM FOR OPTIMAL DOCUMENT SCANNING

(75) Inventors: Depankar NEOGI, Wilmington, MA (US); Steven K. LADD, North Andover, MA (US); Arjun KUMAR, Boxborough, MA (US); Matthew DUGGAN, Boston, MA (US)

Correspondence Address: WILMERHALE/BOSTON, 60 STATE STREET, BOSTON, MA, 02109, US

(73) Assignee: COPANION, INC., Andover, MA (US)

(21) Appl. No.: 12/351,302

(22) Filed: Jan. 9, 2009

Related U.S. Application Data
(60) Provisional application No. 61/020,270, filed on Jan. 10, 2008.

(51) Int. Cl. G06F 3/12; H04N 1/04

(52) U.S. Cl. 358/1.15; 358/474

(57) ABSTRACT

A method of controlling a scanner to improve automatic recognition and classification of scanned physical documents for a document analysis system, which receives and processes jobs containing at least one electronic document from a plurality of users to automatically recognize and classify the job documents into document categories, is disclosed. The method comprises, using a scan control system, obtaining the capability of, and existing scanner settings for, the scanner upon receiving a command to initiate scanning of physical documents; saving the existing scanner settings of the scanner; automatically commanding the scanner to use new scanner settings, wherein the new scanner settings are selected in accordance with the capability of the recognition system; commanding the scanner to begin scanning operation with the new scanner settings; and automatically resetting the scanner settings of the scanner back to the saved existing scanner settings upon completing of the scanning operation.

### CROSS-REFERENCE TO RELATED APPLICATIONS

This application claims priority under 35 U.S.C. §119(e) to U.S. Provisional Patent Application No. 61/020,270, entitled “System for Optical Document Scanning,” filed Jan. 10, 2008; the entire contents of which are incorporated herein by reference in their entirety.

### BACKGROUND

1. Field of the Invention

This invention relates generally to a system and method for scanning paper documents, and more particularly to a system and method for automatically controlling scanner settings and optimizing document images.

2. Description of Prior Art

Paper documents must be scanned before they can be electronically processed or digitally archived. Scanning a document makes a digital copy of the original, just as how photocopying a document makes a paper copy of an original. Photocopying requires two simple steps: loading the document in the copier and pressing the “copy” button. Scanning a document is much more complicated; the University of Massachusetts Amherst website details an 18-step “How to Scan Documents (Windows)” procedure (http://www.oit.umass.edu/classrooms/howto_guides/scan-pc.html.)

Users of scanning systems are required to specify technical parameters such as resolution (96-1200 dots per inch), color depth (black-and-white, 8-bit gray, 24-bit color), dimensions (in inches, millimeters or pixels) and file format (BMP, GIF, JPEG, PDF, TIFF, etc.) Users must make trade-offs between file size, scanning time, image quality and other factors. Users face conflicting advice on determining proper specifications; for example, various “how to” documents advise scanning documents at 100, 150, 300, 400 and 600 dots per inch for optical character recognition (OCR) applications. Consultants report widespread confusion and difficulties among users.

Improper scanner settings can result in poor image quality, poor OCR results, enormous file sizes and other problems. Worse, settings that are appropriate for some pages of a document may be inappropriate for other pages in the same document. When inappropriate settings result in poor quality image files, some or all of the pages in the document require rescanning or interactive image processing with different settings.

In addition to variations introduced by users, scanning results can differ due to variations in image management software. Such software converts raw image data into the specified file formats, color depths, etc. For example, gray scale images may be converted into black-and-white images and the files may be converted to JPEG format. Thus one image management software may produce a high quality image from a page while another image management software may produce a lower quality image.

Further, regardless of the choice of scanner settings and image management software, such settings and software generally process the scanned image as a whole to ease implementation and speed processing. Global image processing can improve the quality of some parts of a document image while reducing the quality of other parts.

In those cases in which documents are scanned locally and images are transferred to servers for remote processing, copies of the scanned images are usually stored locally before transfer. Locally stored image files may be a security vulnerability since they may be viewed, printed, copied, emailed or otherwise improperly accessed or transmitted.

While the prior art utilizes technically trained users and a range of image management software, no combination of the above methods of document scanning (1) makes scanning as simple for users as photocopying, (2) guarantees that appropriate scanner settings are specified, (3) standardizes image conversions, (4) optimizes the quality of entire images and (5) protects the privacy of the owners of the data on the scanned images. What is needed, therefore, is a method of performing document scanning that overcomes the above-mentioned limitations and that includes the features numerated above.

### SUMMARY OF INVENTION

The invention provides systems and methods for optimal document scanning in an automated way so the user need not know the preferred scanning settings, for example, to improve the performance and storage trade-offs of a document recognition and classification system.

Under one aspect of the invention, a document analysis system is provided that receives and processes jobs from a plurality of users, in which each job may contain multiple electronic documents, and that includes a recognition system for automatically recognizing and classifying the job documents into document categories. A scan control system, upon receiving a command to initiate scanning of physical documents, obtains the capability of, and existing scanner settings for, the scanner. The scan control system saves the existing scanner settings of the scanner and automatically commands the scanner to use new scanner settings, in which the new scanner settings are selected in accordance with the capability of the recognition system in order to automatically recognize image and text features of each received electronic document. The scan control system commands the scanner to begin scanning operation with the new scanner settings and automatically resets the scanner settings of the scanner back to the saved existing scanner settings upon completing of the scanning operation.

### BRIEF DESCRIPTION OF DRAWINGS

Various objects, features, and advantages of the present invention can be more fully appreciated with reference to the following detailed description of the invention when considered in connection with the following drawings, in which like reference numerals identify like elements.

FIG. 1 shows an optical document scanning system 100 in accordance with some embodiments of the present invention.

FIG. 2A shows a controller system 120 in accordance with some embodiments of the present invention.

FIG. 2B shows entry points for communicating between elements in accordance with some embodiments of the present invention.

FIG. 2C shows various TWAIN states in accordance with some embodiments of the present invention.

FIG. 3 shows an image management system 223 in accordance with some embodiments of the present invention.

FIG. 4 illustrates a portion of W-2 scanned under alternate scenarios in accordance with some embodiments of the present invention.

FIGS. 5A-B show a web browser based scanning process using Java applet in accordance with some embodiments of the present invention.

FIG. 6 illustrates an exemplary computer system on which certain embodiments of the invention may run.

### DETAILED DESCRIPTION

Preferred embodiments of the present invention provide methods and systems for automatically controlling scanner settings, optimizing the resulting images and securely transmitting the images to a remote server. In this fashion, the process is automated and a user need not know the best scanner settings, for example, for a document recognition system. In addition, the scanner settings used may be non-intuitive and selected to improve various performance and storage trade-offs of the document analysis system.

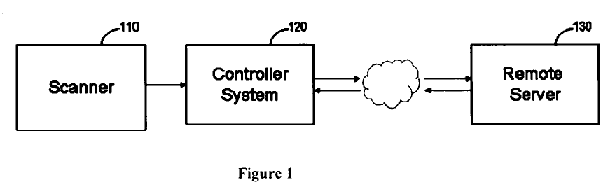

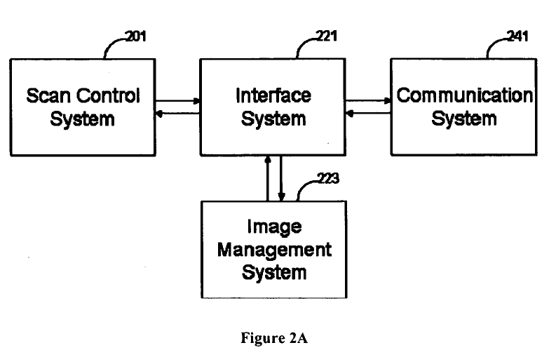

FIG. 1 is a system diagram of an optimal document scanning system 100 according to a preferred embodiment of the invention. System 100 has a scanner 110, a controller system 120 and a remote server 130. The scanner is connected to the controller system either directly or over a network. The controller system is connected to the remote server either directly or over a network such as a local-area network (LAN,) a wide-area network (WAN) or the Internet. The preferred implementation transfers all data over the network using Secure Sockets Layer (SSL) technology with enhanced 128-bit encryption. Encryption certificates can be purchased from well respected certificate authorities such as VeriSign and Thawte or can be generated by using numerous key generation tools in the market today, many of which are available as open source. Alternatively, the files may be transferred over a non-secure network, albeit in a less secure manner.

System 110 is a scanner. Under preferred embodiments, conventional scanners may be used such as those from Bell+Howell, Canon, Epson, Fujitsu, Kodak, Panasonic and Xerox. The scanner captures an image of the scanned document as a computer file; the file is often in a standard format such as PDF, TIFF, BMP, or JPEG.

System 120 is a controller system. Under typical operation the controller system controls the scanner, optimizes document images and transfers scanned document images either directly or over a network to a server system. The controller system is described in greater detail below.

System 130 is a server system. The server system receives the scanned document images from the controller system either directly or over a network. The server system is described in greater detail below.

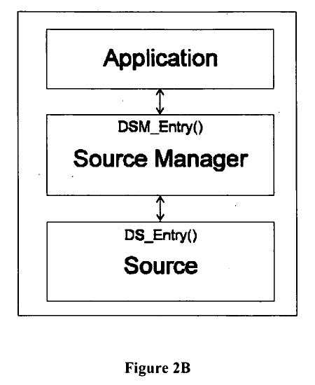

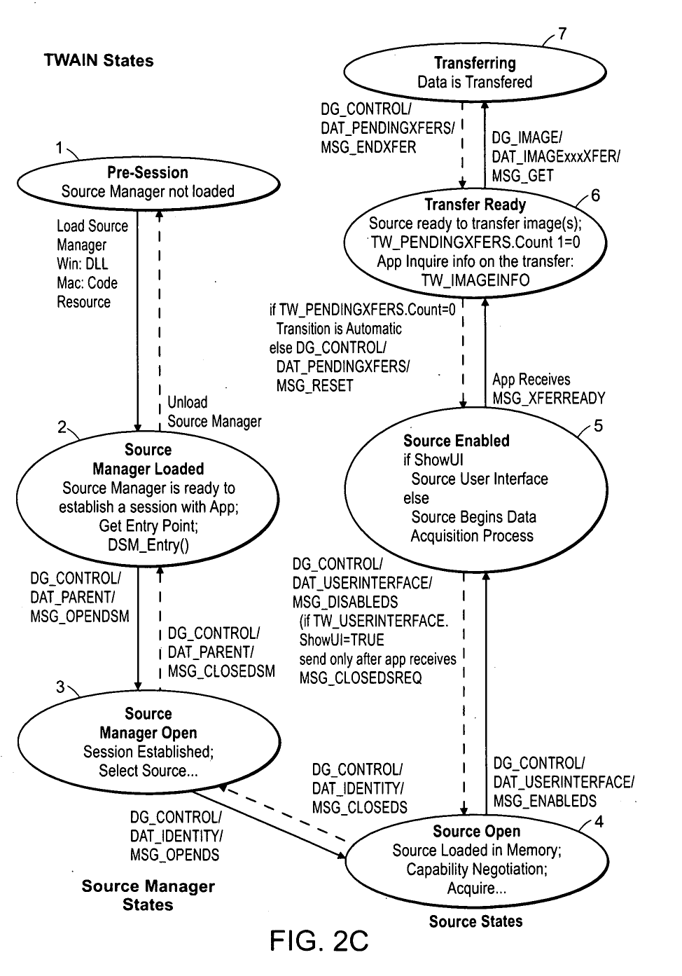

FIG. 2A is system diagram of the controller system 120 according to a preferred embodiment of the invention. System 120 has a scan control system 201, an interface system 221, a communication system 241 and an image management system 223. The scan control system communicates with the interface system via software within a computer system. The interface system communicates with the communication system via software within a computer system. The interface system communicates with the image management system via software within a computer system.

System 201 is a scan control system. Under preferred embodiments the scan control system obtains the scanner capabilities and existing settings; for example, the existing settings may be single-sided at 600 dots per inch (dpi) and 24 bit color with JPEG compression and auto-feed. Under preferred embodiments, the scan control system obtains the scanner capabilities and existing settings via a TWAIN interface.

The scan control system is illustrated as the “Application” in FIG. 2B. In order to obtain the scanner capabilities and existing settings, the scan control system contacts the scanner (“Source”) via the “Source Manager.” The scan control system specifies which element, Source Manager or Source, is the final destination for each requested operation.

TWAIN states and state transitions are shown in FIG. 2C. Under preferred embodiments the scan control system manages the following TWAIN state transitions:

State 1 to 2: Load Source Manager and Get DSM_Entry

State 2 to 3: Open Source Manager

State 3 to 4: Select and open Source

State 4 to 5: Negotiate Capabilities of and Request Data from Source

State 5 to 6: Recognize that the Data Transfer is Ready

State 6 to 7: Start and Perform the Transfer

State 7 to 6 to 5: Conclude the Transfer

State 5 to 1: Disconnect the TWAIN Session

Scanner capabilities and existing settings are obtained, under TWAIN, during the transition from state 4 to 5. A set of the scanner capabilities and scanner settings includes:

Automatic Scanning
CAP_AUTOSCAN
   Enables the source's automatic document scanning process
CAP_CLEARBUFFERS
MSG_GET
   reports presence of data in scanner's buffers;
MSG_SET
   clears the buffers.
CAP_MAXBATCHBUFFERS
   Describes the number of pages that the scanner can buffer when CAP_AUTOSCAN is enabled

Device Parameters
CAP_DEVICEONLINE
   Determines if hardware is on and ready
ICAP_PHYSICALHEIGHT
   Maximum height Source can acquire
ICAP_PHYSICALWIDTH
   Maximum width Source can acquire

Image Parameters for Acquire
ICAP_ORIENTATION
   Defines which edge of the paper is the top: Portrait or Landscape
ICAP_ROTATION
   Source can, or should, rotate image this number of degrees
ICAP_SHADOW
   Darkest shadow, values darker than this value will be set to this value
ICAP_XSCALING
   Source Scaling value (1.0=100%) for x-axis
ICAP_YSCALING
   Source Scaling value (1.0=100%) for y-axis

Image Type
ICAP_BITDEPTH
   Pixel bit depth for Current value of ICAP_PIXELTYPE
ICAP_HALFTONES
   Source halftone patterns
ICAP_PIXELTYPE
   The type of pixel data (B/W, gray, color, etc.)
ICAP_THRESHOLD
   Specifies the dividing line between black and white values

Paper Handling
ICAP_FEEDERTYPE
   Allows application to set scan parameters depending on the type of feeder being used
CAP_AUTOFEED
   MSG_SET to TRUE to enable Source's automatic feeding

Resolution
ICAP_XNATIVERESOLUTION
   Native optical resolution of device for x-axis
ICAP_XRESOLUTION
   Current/Available optical resolutions for x-axis
ICAP_YNATIVERESOLUTION
   Native optical resolution of device for y-axis
ICAP_YRESOLUTION
   Current/Available optical resolutions for y-axis

Bar Code Detection Search Parameters
ICAP_SUPPORTEDBARCODETYPES
   Provides a list of bar code types detectable by current data source
ICAP_BARCODEDETECTIONENABLED
   Turns bar code detection on and off

Capability Negotiation Parameters
CAP_EXTENDEDCAPS
   Capabilities negotiated in States 5 & 6
CAP_SUPPORTEDCAPS
   Inquire Source's capabilities valid for MSG_GET

Compression
ICAP_BITORDERCODES
   CCITT Compression
ICAP_CCITTKFACTOR
   CCITT Compression
ICAP_JPEGPIXELTYPE
   JPEG Compression

As an example, the existing settings may be:
Single-side (duplex disabled)
600 dpi optical resolution (x axis and y axis)
24 bit color
JPEG compression
Auto-feed enabled

The scan control system then changes the settings of the scanner per requirements received from the interface system; for example, requirements for a document automation application may set the scanner to scan pages double-sided at 300 dpi with eight bits of gray scale. The scan control system then commands the scanner to begin operation and receives the scanned image file from the scanner. Once the document has been scanned, the scan control system resets the settings to single-side, 600 dpi and 24 bit color. The scan control system also detects problems (such as scanner jams) and raises alarms when problems occur.

System 221 is an interface system. Under preferred embodiments, the interface system provides a user interface and manages the control system, the communication system and the image management system by sending and receiving commands and data to and from these systems. Under preferred embodiments, the user interface runs in a browser and presents a user with a single “scan” button to initiate a document scanning operation; no scanner settings need be specified by the user. Optionally, the “scan” button is a physical button that is part of the scanner. Under preferred embodiments, the user interface optionally presents job status information. Under preferred embodiments, the interface system opens a connection to the server and negotiates what scanner settings to use. The scanner settings are determined based on the application requirements, local system resources and available bandwidth between the controller system and the server. Under preferred embodiments, the interface system performs system checks on CPU, memory and other computer elements, loads device drivers and libraries, unloads device drivers and libraries, selects scanner drivers, enables applications/applets and disables applications/applets.

System 241 is a communication system. Under preferred embodiments, the communication system manages the SSL connection and associated data transfer with the server system. Under preferred embodiments, the communication system initiates secure connections with server, manages communications handshaking with the server, analyzes communications bandwidth, secures the communications channel, guarantees delivery of data, guarantees receipt of data and handles multiple protocols such as UDP, TCP, TLS and HTTP. Under preferred embodiments, the image can be saved on the server by opening an HTTP socket to the server and then streaming the image to the server. Such communication and transfer can be performed securely using many standard encryption methods.

Once all the documents have been scanned, the entire document can be saved locally or remotely. If saved remotely, the document needs to be made persistent and the connection between the client and the server needs to be closed.

System 223 is an image management system. Under typical operation, the image management system enhances the image quality of scanned images for a given resolution and other scanner settings. The image management system is described in greater detail below.

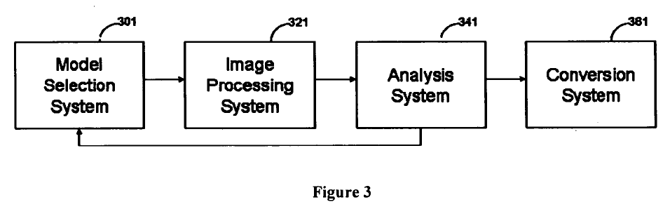

FIG. 3 illustrates a system diagram of an image management system 223 according to a preferred embodiment of the invention. System 223 has a model selection system 301, an image processing system 321, an analysis system 341 and a conversion system 361. The model selection system communicates with the image processing system via software within a computer system. The image processing system communicates with the analysis system via software within a computer system. The analysis system communicates with the conversion system via software within a computer system.

System 301 is a model selection system. Under preferred embodiments, the model selection system determines whether thresholding should be performed on the scanned image and, if so, determines which thresholding model to use. Under preferred embodiments, the model selection system receives feedback regarding the previous result from the analysis system and determines from that feedback whether and how the thresholding model should be updated. Under preferred embodiments, the model selection system communicates the selected model(s) to the image processing system

System 321 is an image processing system. Under preferred embodiments, the image processing system captures images in bitmap or other formats, receives thresholding model(s) from the model selection system, evaluates and performs local thresholding and performs other image processing steps, such as de-skewing and orientation correction to create a clean image.

Under preferred embodiments, the thresholding subsystem (not shown) converts a scanned gray scale image to a binarized black-and-white image without significant loss of optical properties on the image. The thresholding subsystem selection model takes into consideration multiple factors including the system resources, any bandwidth requirement, pixel distribution over the different area of the document, etc.

The skew correction subsystem (not shown) fixes small angular rotations of the entire document image. Skew correction is important for the document analysis module because it improves text recognition, simplifies interpretation of page layout, improves baseline determination, and improves visual appearance of the final document. Several available image processing libraries do skew correction. The preferred implementation of skew detection is part of the open source Leptonica image processing library.

The orientation correction subsystem (not shown) aligns document images so that they can be most easily read. Documents, originally in either portrait or landscape format may be rotated by 0, 90, 180 or 270 degrees during scanning. There are three preferred implementations of orientation correction.

The first method detects blocks of text in the image and measures each with respect their block height and width. In portrait documents, the average width is more than average height. An average count of the width and height is performed and if the width to height ratio is above a certain threshold, the document is determined to be portrait or landscape.

The second method performs a baseline analysis, counting the pixels in ascenders and descenders along any line in a document. Heuristically, the number of ascenders is found to be more than the number of descenders in English language documents that are correctly oriented. The document is oriented so that ascenders outnumber descenders.

The third method performs OCR is on small words or phrase images at all four orientations: 0, 90, 180 and 270 degrees. Small samples are selected from a document and the confidence is averaged across the sample. The orientation that has the highest confidence determines the correct orientation of the document.

System 341 is an analysis system. Under preferred embodiments, the analysis system evaluates the quality of the output of the image processing system, reports quality metrics for the evaluated image, and instructs the image management system to do another pass with a different model if necessary. Under preferred embodiments, the analysis system scores certain properties including image size reduction, quality of the binarized image, and localized conversion scores. Under preferred embodiments, a feedback loop is utilized whereby scores are given certain weights in the heuristic model that are appropriately adjusted to produce higher quality images.

System 361 is a conversion system. Under preferred embodiments, the conversion system converts the digital image from one format (such as TIFF) to another (such as PDF.) Under preferred embodiments, the conversion system optionally functions as a security system as well and encrypts the image based on parameters or instructions.

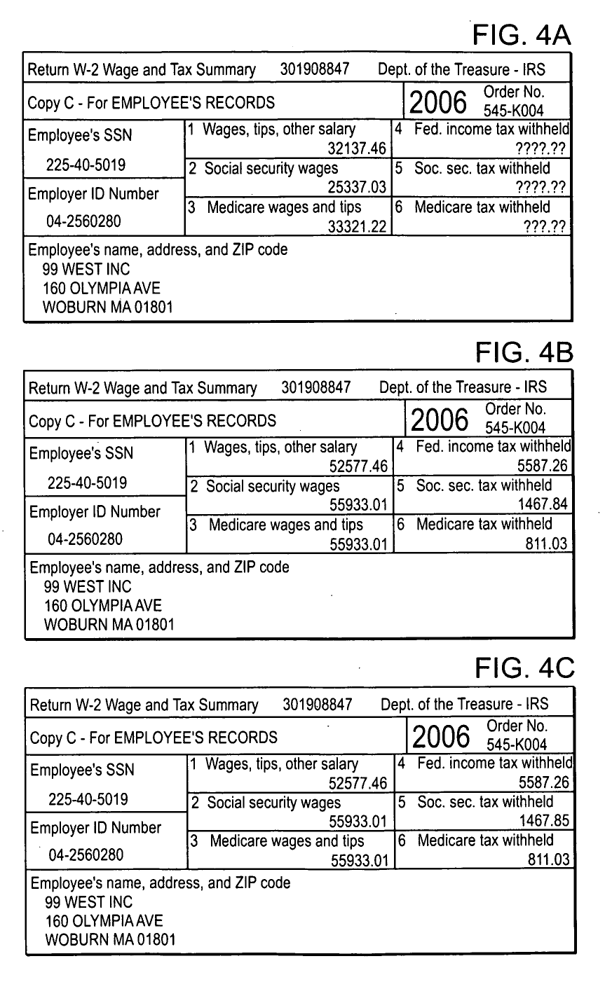

The system described above may be better understood with an example that illustrates how the optimal document scanning system operates. In the example a scanner is set to scan documents for archival purposes, say invoices received in an accountant's office. In order to minimize the sizes of the resulting image files, the scanner is set to scan at a resolution of 150 dpi, single-sided, black-and-white images that are saved in PDF format. These are the “existing settings” referred to in the description of System 201 above. An illustration of scanning a portion of a W-2 with these settings is shown as “A” in FIG. 4. The form and its text can be recognized and read with significant difficulty due to the low resolution scan and the artifacts of the gray background on the original form; the resulting image file size is very small.

The accountant receives 50 pages of “source documents” for preparing a client's personal income tax returns; these source documents include W-2's, K-1's, 1099's, 1098's and other forms and information needed to prepare the client's returns. Manually entering all the data from the source documents into tax return software (such as TurboTax, Lacerte or ProSeries from Intuit; ProSystem fx Tax from CCH; or UltraTax or GoSystem Tax RS from Thomson Reuters) and then scanning those documents for archiving would take an hour or longer.

Instead, utilizing a system with the present invention, the accountant opens a web browser on his computer, navigates to a website of a tax document automation service and logs in. Using web-based application software, he specifies the client for whom the accountant will prepare a tax return. Next, he clicks a “scan” button on the web browser based application software. The application software is a Java based applet. The applet on his browser communicates with TWAIN driver software which initiates the scan of the documents in his scanner at 300 dpi, double-sided, 8-bit gray scale in TIFF format.

The scanner settings are adjusted by the applet via the TWAIN driver and the 50 pages of client documents are scanned accordingly based on dynamic settings and parameters. The scanner parameters are software controlled and can be updated remotely from a server. An illustration of scanning a portion of a W-2 with these settings is shown as “B” in FIG. 4. The form and its text can be recognized and read with some difficulty due to the medium resolution scan and the artifacts of the gray background on the original form; the resulting image file size is very large (about 32 times the size of the file for image A).

The image model selection system of the present invention, running as part of the applet on the accountant's browser, recognizes the document as having a gray background due to the pixel density of the image. Accordingly, it determines that the image processing system should binarize the image “B”. An illustration of scanning a portion of a W-2 with the same settings as used to scan “B” and binarized as described above is shown as “C” in FIG. 4. The form and its text can be recognized very easily due to the medium resolution scan (compatible with OCR systems) and the white background on the processed form. The resulting image file size is small (about ⅛th the size of image B and 4 times the size of image A).

The analysis system confirms that the resulting image files are of acceptable quality. The conversion system converts the file to PDF format and, optionally, encrypts the image before transmission. No copies of the scanned or processed images are saved on the accountant's computer or any storage device on his local area network.

The final image files are transmitted to the server using SSL. These modest-sized files with high quality images are used by the server running tax document automation software to recognize the documents, extract the data and make entries automatically into the tax return software. This concludes the example that illustrates how the optimal document scanning system operates.

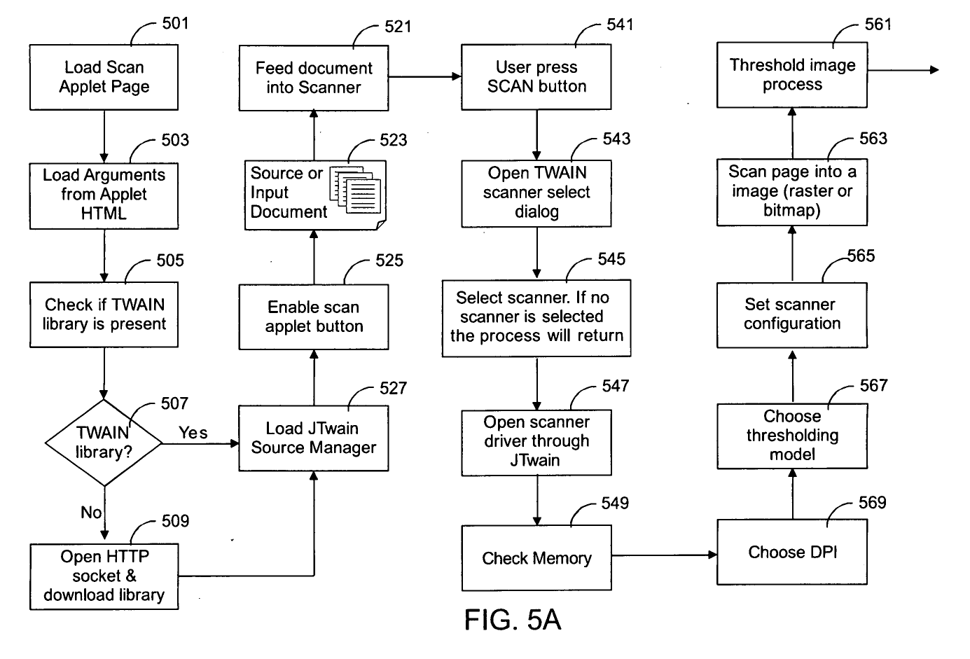

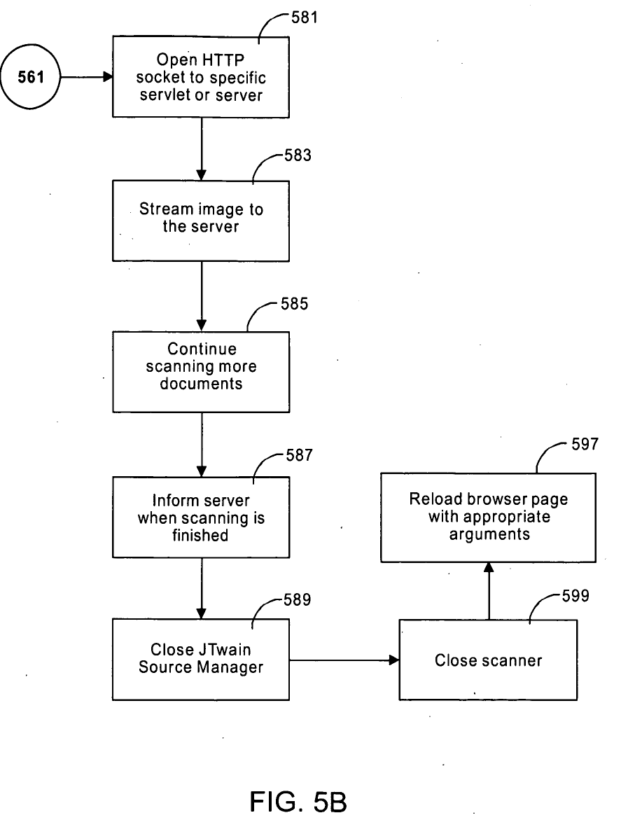

FIG. 5A and FIG. 5B show the process of a browser based scanning system using a Java applet under preferred embodiments.

501 Load the scan applet page

503 Arguments from applet HTML are loaded

505 TWAIN library check is performed

527 AspriseJTwain.dll is loaded if present

509 If the AspriseJTwainII is not found, an HTTP socket is opened and the library is downloaded, and then loaded.

527 Next, JTwain source manager is retrieved and loaded into memory.

525 Scan applet button is rendered on the corresponding web page.

523 Input documents are selected.

521 Documents are properly positioned in the scanner.

541 Scan button pressed.

543 TWAIN scanner selected dialog is opened through JTwain library.

545 Selected scanner is returned; if scanner is null indicating one was not chosen, the process returns.

547 The scanner interface is opened through JTwain library.

549 The available applet memory is checked by the software, and compared to DPI memory requirements that have been passed through HTML arguments on the browser.

569 The maximum DPI is calculated that allows for grayscale scan and thresholding. The minimum DPI is chosen if resources fall below the minimum level and thresholding is turned off.

567 If the thresholding is selected, appropriate thresholding model is chosen.

565 The scanner is configured with the DPI determined by the previous step, the scanner configure interface is disabled, grayscale is set, feeder is enabled, auto feed is enabled, and duplex is enabled.

563 The first page is scanned through JTwain, retrieved as a bitmap or raster image.

561 The image raster is read into memory, converting multiple color palates to one grayscale if necessary on the fly.

581 If thresholding is enabled, the image is binarized using the chosen thresholding algorithm.

583 An HTTP socket is opened to a servlet address specified in the applet HTML arguments. The image is streamed to the server.

585 If more pages are present, the process returns to step 563.

587 When the job has finished, a multipart post request is sent to the servlet with an argument indicating the job has finished.

589 The JTwain source manager is closed.

599 Closes the scanner interface.

597 The web applet thread waits for two seconds, and reloads the web page, with the appropriate arguments.

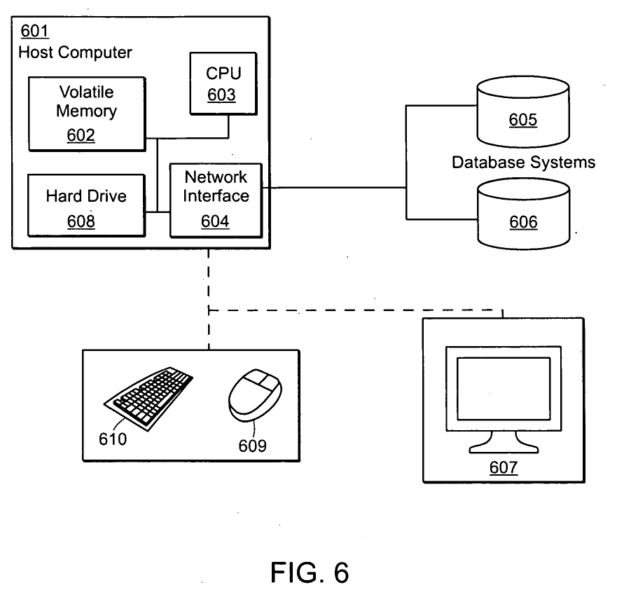

FIG. 6 is a diagram that depicts the various components of a computerized document analysis system, according to certain embodiments of the invention. The method of controlling a scanner in document analysis system may be performed by a host computer, 601 that contains volatile memory, 602, a persistent storage device such as a hard drive, 608, a processor, 603, and a network interface, 604. Using the network interface, the system computer can interact with databases, 605, 606. Although FIG. 6 illustrates a system in which the system computer is separate from the various databases, some or all of the databases may be housed within the host computer, eliminating the need for a network interface. The programmatic processes may be executed on a single host, as shown in FIG. 6, or they may be distributed across multiple hosts.

The host computer shown in FIG. 6 may serve as a document analysis system. The host computer receives electronic documents from multiple users. Workstations may be connected to a graphical display device, 607, and to input devices such as a mouse 609, and a keyboard, 610.

In some embodiments, the flow charts included in this application describe the logical steps that are embodied as computer executable instructions that could be stored in computer readable medium, such as various memories and disks, that, when executed by a processor, such as a server or server cluster, cause the processor to perform the logical steps.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. In a document analysis system that receives and processes jobs from a plurality of users, in which each job may contain multiple electronic documents, and that includes a recognition system for automatically recognizing and classifying the job documents into document categories, a method of controlling a scanner to improve automatic recognition and classification of scanned physical documents, the method comprising:
a scan control system, upon receiving a command to initiate scanning of physical documents, obtaining the capability of, and existing scanner settings for, the scanner;
the scan control system saving the existing scanner settings of the scanner;
the scan control system automatically commanding the scanner to use new scanner settings, said new scanner settings selected in accordance with the capability of the recognition system in order to automatically recognize image and text features of each received electronic document;
the scan control system commanding the scanner to begin scanning operation with the new scanner settings; and
the scan control system automatically resetting the scanner settings of the scanner back to the saved existing scanner settings upon completing of the scanning operation.

2. The method of claim 1, further comprising the scan control system saving the images of the scanned physical documents into corresponding electronic documents.

3. The method of claim 1, wherein the scanner settings of the scanner comprises at least one of image resolution, color depth, image dimension, and file format.

4. The method of claim 1, further comprising an image quality analysis system determining whether the quality of the images of the scanned physical documents is acceptable for the recognition system to automatically recognize and classify the scanned physical documents.

5. The method of claim 4, further comprising, if the quality is determined to be not acceptable, the image quality analysis system feeding back to the scan control system the information necessary for the scan control system to adjust the new scanner settings of the scanner.

6. The method of claim 1, wherein the scan control system is directly connected to the scanner.

7. The method of claim 1, wherein the scan control system is connected to the scanner over a network.

8. The method of claim 7, wherein the scan control system selects the new scanner settings in accordance with the available bandwidth of the network connecting the scan control system and the scanner.

9. The method of claim 7, wherein the scan control system includes a communication system for managing the transfer of the electronic documents corresponding to the scanned physical documents over the network.

10. The method of claim 9, wherein the managing the transfer of the electronic documents comprises managing a secure sockets layer connection with a multi-bit encryption.

11. The method of claim 1, further comprising:
an image processing system determining whether to convert the images of the scanned physical documents into binarized black-and-white images;
the image processing system, upon determining to convert the images, determining a threshold model for converting the images; and
the image processing system performing binarization in accordance with the thresholding model.
